(19) United States
(12) Patent Application Publication
(10) Pub. No.: US 2007/0217630 A1
(43) Pub. Date: Sep. 20, 2007

(54) Electrified stringed instrument with on-board DJ fader

(76) Inventor: Jamie Shea Keogh, Boca Raton, FL (US)

Correspondence Address: JAMIE SHEA KEOGH, 1013 W. CAMINO REAL, BOCA RATON, FL, 33486, US

(21) Appl. No.: 11/377,122

(22) Filed: Mar. 17, 2006

(51) Int. Cl. H04B 1/00

(52) U.S. Cl. 381/119

(57) ABSTRACT

An electrified, stringed instrument with an on-board DJ fader which allows you to achieve a “DJ scratch effect”, by using the fader to physically modulate the sound. This modulation is precisely defined by using a curve controlled potentiometer set to the “sharp position”. This DJ fader also has a reverse switch allowing you to modulate the signal using the adjacent side of the fader. The DJ fader is mounted on or within the instrument for easy access. There is also a bypass switch mounted on the instrument allowing you to bypass all functions of the fader and use the instruments pick-ups normally.

### BACKGROUND OF THE INVENTION

With recent developments in the art of the DJ, it has become possible to precisely modulate sound by using a DJ fader. In the past DJ's could only use a crossfader to fade from one channel of audio to another. Now DJ's can play the fader as an instrument to create advanced, percussive, rhythmic patterns of music known to the public as scratching/transforming. Generally this fader does not control the audio directly but sends a control voltage to a voltage controlled device such as a resistive opto-coupler, or some digital control means. This allows the sharpness or cut-in point of the sound to be precisely defined as the fader is moved back and forth. This is essential toward achieving this rhythmic/percussive modulation of the sustaining sound known as “scratching/transforming”.

DJ's [disk jockeys] use a crossfader specifically on a DJ mixer (a linear motion potentiometer [not rotary] that fades between one channel of music and another) to perform a rhythmic effect known as “scratching or transforming”.

In the past, players of electrified stringed instruments have attempted to achieve rhythmic/percussive modulation of sustaining sounds by using a [built-in] pick-up toggle switch. This switch is intended for toggling between pick-ups on an electrified stringed instrument, not for advanced rhythmic/percussive modulation of the sustaining sounds known as “scratching/transforming”.

Players of electrified string instruments such as electric guitars, electric bass guitars, and electric violins have no practical way to achieve the “DJ scratching/transforming effect”. This invention solves this problem. Using a resistive opto-coupler with curve shaping circuit is a well known way of making a DJ fader, therefore this in itself is not unique. What is unique is putting a “DJ fader system”, inside an electrified stringed instrument. A prototype has been built by the inventor, [Jamie Keogh]. He has created a DVD demonstrating the unique performance capabilities of the “guitar with a built-in DJ fader”.

### SUMMARY OF INVENTION

It is therefore an objective of the present invention to provide an electrified stringed instrument with an on-board DJ fader for the purpose of physically modulating the sound to create the effect known to the public as “scratching/transforming”. This effect is created by using a DJ fader with a specially modified “sharp curve”, that is necessary for achieving the “scratch/transform effect”.

It is a further objective of the present invention to provide an electrified stringed instrument with a built-in DJ fader that has a reverse switch which allows the fader cut-in point to be switched to the adjacent side of the fader. Another objective of the present invention to provide an electrified stringed instrument with a built-in DJ fader that has a bypass switch that allows the fader and all its functions to be bypassed.

The output of the guitar's magnetic pickup is connected to an audio pre-amplifier. This pre-amplifier is connected to a voltage controlled element such as a VCA or a resistive opto-coupler [CDS photocell/LED]. This pre-amplifier can also be connected to a digitally controlled audio means such as a digital potentiometer controlled by a microcontroller. The output of this device is connected to the guitars output jack or it may be connected through a buffer stage.

The voltage controlled element is connected to a linear fader [a linear potentiometer specifically designed for use as an audio fader] through a “curve control” circuit known in the art of making DJ mixers with curve controls. Alternatively, the fader can go through a ADC [analog to digital converter] microcontroller and “digital pot” chip. The curve is adjusted by code within the micro controller. This “curve control”, is necessary for achieving the “DJ scratch/transform effect”.

These and other objectives and features of the present invention will be apparent from the following detailed description of the preferred embodiments.

### BRIEF DESCRIPTION OF THE DRAWINGS

FIG. 1 is a block diagram of a typical embodiment of the invention.

FIG. 2 is a detailed drawing of an electric guitar with a typical embodiment of this invention shown.

FIG. 3 is a graph of a linear fader voltage vs. position curve illustrating what is referred to in this invention as the “sharp” curve used to achieve the “DJ scratching/transforming effect”

FIG. 4 is a graph of a linear fader voltage vs. position curve illustrating a typical linear potentiometer “fade” curve found in prior art.

### DETAILED DESCRIPTION OF PREFERRED EMBODIMENTS

For the purposes of the following detailed description, various terms will first be defined for simplification of the following discussion

Electrified Stringed Instrument: The term “Electrified Stringed Instrument” describes a musical instrument containing a “String” which can be amplified by an electrified microphone pick-up.

DJ Fader: A slide potentiometer that sends a control voltage to a voltage controlled device such as a resistive opto-coupler, or some digital control means. This allows the sharpness or cut-in point of the sound to be precisely defined as the fader is moved back and forth. This is essential toward achieving this rhythmic/percussive modulation of the sustaining sound known as “scratching/transforming”.

Scratching/Transforming: Scratching and Transforming are well known terms in the art of the DJ. These terms describe hand motions using the DJ fader. These motions using the DJ fader produce specific sounds that are well known in the art of the DJ. These sounds are specific, advanced, percussive, rhythmic patterns of music known to the public. This invention proves that this rhythmic sound known to the world as scratching/transforming, can be created using an electrified, stringed instrument with a built-in DJ fader.

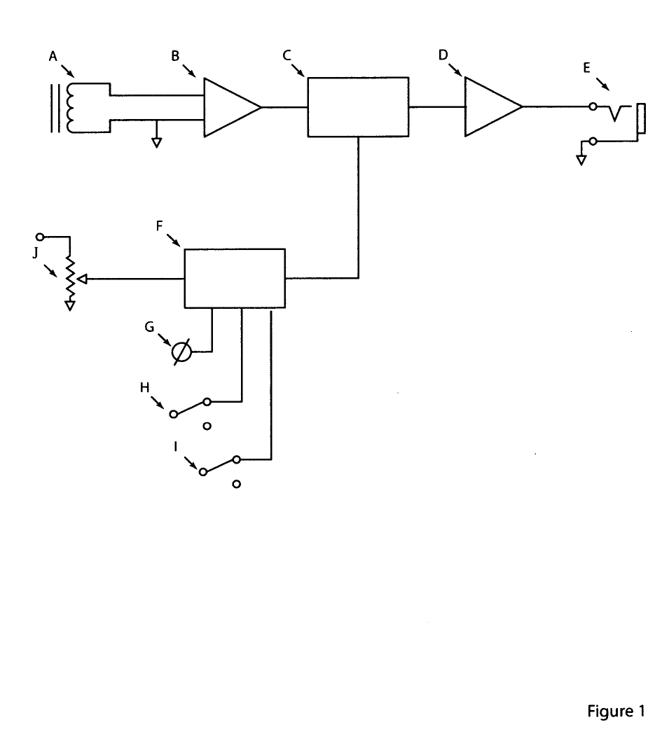

Referring now to FIG. 1, letter (A) represents a microphone pickup on a stringed instrument, used to electrify the signal. Letter (B) represents the preamp of the microphone pickup, used to electrify the signal of a stringed instrument. Letter (C) represents the VCA of the microphone pickup, used to electrify the signal of a stringed instrument. Letter (D) represents the output preamp of the microphone pickup, used to electrify the signal of a stringed instrument. Letter (E) represents the final output of the microphone pickup, used to electrify the signal of a stringed instrument. Letter (F) represents the fader taper curve control, which is used to adjust the cut-in point of the signal according to the positioning of the fader. Letter (G) represents the curve adjustment potentiometer, which is used to adjust the cut-in point of the signal according to the positioning of the fader. Letter (H) represents the curve reverse switch, which is used to reverse the cut-in point of the signal to the adjacent side of the fader. Letter (I) represents the fader bypass switch, which is used to bypass all the functions of the fader and use the instrument pick-up normally. Letter (J) represents the actual fader, which is used to physically modulate the signal.

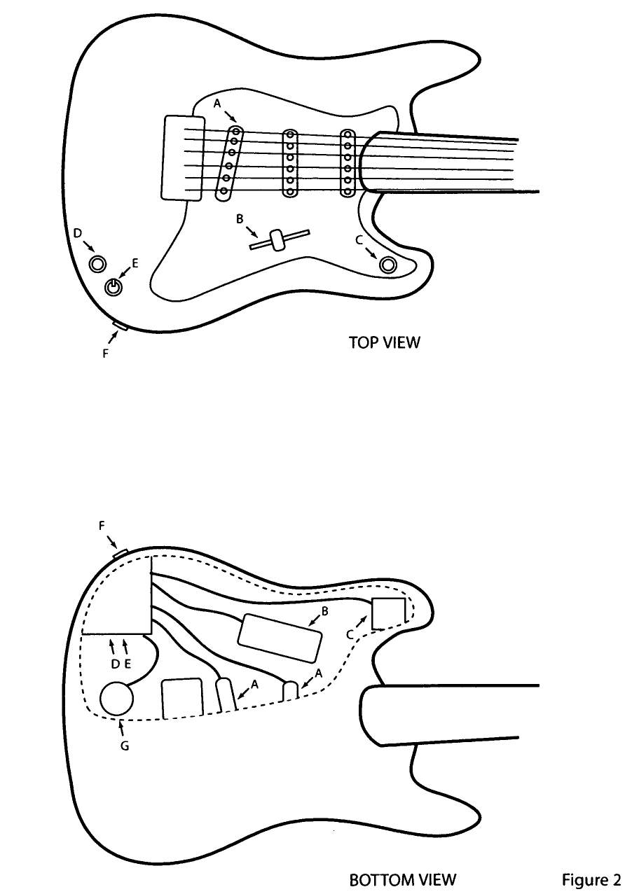

Referring now to FIG. 2, letter (A) represents a microphone pickup on a stringed instrument, used to electrify the signal. Letter (B) represents the slide potentiometer (fader), which is used to physically modulate the instruments output signal. Letter (C) represents the fader reverse switch, which is used to reverse the cut-in point of the signal to the adjacent side of the fader. Letter (D) represents the fader bypass switch, which is used to bypass all the functions of the fader and use the instrument pick-up normally. Letter (E) represents the curve adjustment potentiometer, which is used to adjust the cut-in point of the signal according to the positioning of the fader. Letter (F) represents the electrified stringed instruments output jack, which is used to send the signal to an amplifier or external device.

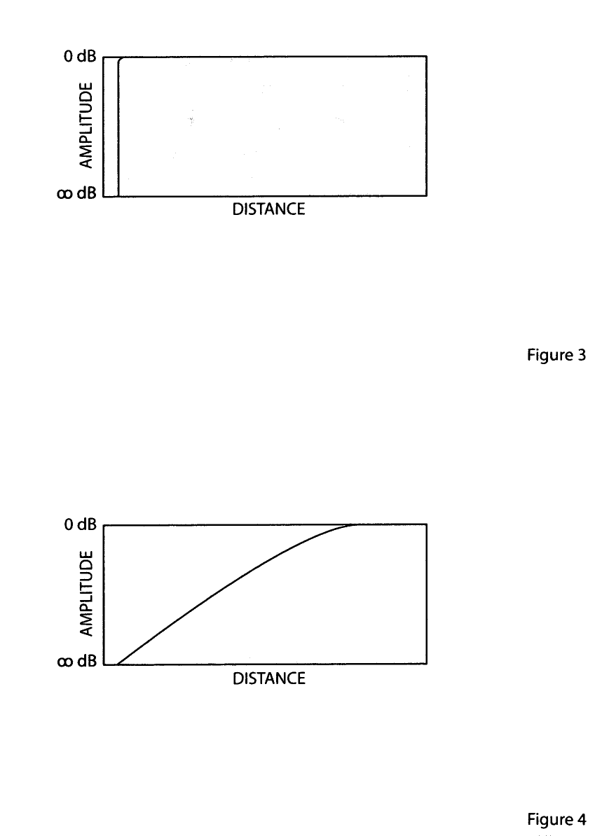

Referring now to FIG. 3. FIG. 3 is a graph of a linear fader voltage vs. position curve illustrating what is referred to in this invention as the “sharp” curve used to achieve the “DJ scratching/transforming effect”

Referring now to FIG. 4. FIG. 4 is a graph of a linear fader voltage vs. position curve, illustrating a typical linear potentiometer “fade” curve found in prior art.

See Drawings.

What is claimed:

1. A DJ fader, designed for a specific percussive/rhythmic effect known to Dj's and the public as “scratching/transforming”, placed inside an electrified stringed instrument such as an electric guitar, electric bass, or electric violin.

2. An electrified, stringed instrument with an on-board DJ fader.

3. An electrified, stringed instrument with an on-board DJ fader according to claim 2, with a curve control potentiometer.

4. An electrified, stringed instrument with an on-board DJ fader according to claim 2, with a curve controlled by a multi-position switch.

5. An electrified, stringed instrument with an on-board DJ fader according to claim 2, with a curve fixed to a “sharp position” [the “sharp position” of the fader is what distinguishes a DJ fader designed for “scratching”, from a normal audio crossfader.

6. An electrified, stringed instrument with an on-board DJ fader according to claim 2, with a VCA resistive opto-coupler.

7. An electrified, stringed instrument with an on-board DJ fader according to claim 2, with a digital potentiometer with a microcontroller as the control means.
